(19) United States
(12) Patent Application Publication
(10) Pub. No.: US 2021/0387557 A1
(43) Pub. Date: Dec. 16, 2021

(54) Air Temperature-Controllable Module

(71) Applicant: Gentherm GmbH, Odelzhausen (DE)

(72) Inventors: Alexander Himmelreich, Augsburg (DE); Witalili Himmelreich, Gersthofen (DE); Dan Botez, Augsburg (DE)

(21) Appl. No.: 17/286,861

(22) PCT Filed: Oct. 22, 2019
(86) PCT No.: PCT/DE2019/000281

§ 371 Date: Apr. 20, 2021

(30) Foreign Application Priority Data
Oct. 22, 2018 (DE) 10 2018 008 318.8

(51) Int. Cl. B60N 3/10; B60H 1/00

(52) U.S. Cl. CPC B60N 3/104; B60H 1/00828; B60H 1/00542; B60H 1/00478

(57) ABSTRACT

An air temperature-controllable module, for a temperature-controllable storage unit, having an air temperature-controllable unit including a useful air temperature-controllable region, a waste air temperature-controllable region, and at least one thermoelectric device including a useful air side and a waste air side, the useful air side connected to the useful air temperature-controllable region and the waste air side connected to the waste air temperature-controllable region, a useful air path for a useful air flow extending from a useful air inlet to a useful air outlet and the useful air temperature-controllable region of the air temperature-controllable unit connecting to the useful air outlet, and a waste air path for a waste air flow extending from a waste air inlet to a waste air outlet and connecting the waste air temperature-controllable region of the air temperature-controllable unit to the waste air outlet.

### FIELD

The invention relates to an air temperature-controllable module, particularly for a temperature-controllable storage unit, having an air temperature-controllable unit comprising a useful air temperature-controllable region, a waste air temperature-controllable region and at least one thermoelectric device, the at least one thermoelectric device comprising a useful air side and a waste air side and the useful air side being connected to the useful air temperature-controllable region in a heat-transmitting manner and the waste air side being connected to the waste air temperature-controllable region in a heat-transmitting manner, a useful air path for a useful air flow, the useful air path extending from a useful air inlet to a useful air outlet and the useful air temperature-controllable region of the air temperature-controllable unit connecting to the useful air outlet in a fluid-conducting manner, and a waste air path for a waste air flow extending from a waste air inlet to a waste air outlet and connecting the waste air temperature-controllable region of the air temperature-controllable unit to the waste air outlet in a fluid-conducting manner.

The invention further relates to a temperature-controllable storage unit, particularly for a vehicle, having an air temperature-controllable module for temperature control of air and a temperature-control container being set up to receive one or more objects to be temperature controlled in a receiving region, a useful air path of the air temperature-controllable module connecting a useful air temperature-controllable region of the temperature control unit to the receiving region of the temperature-control container in a fluid-conducting manner and a waste air path of the air temperature-controllable module connecting a waste air temperature-controllable region of the air temperature-controllable unit to the surroundings of the storage unit in a fluid-conducting manner.

### BACKGROUND

Known temperature-controllable storage units, such as temperature-controllable cup holders, use thermoelectric devices or miniature compressors to achieve a temperature-control effect. The known systems regularly have a temperature-control surface which is to be brought into contact with the object to be temperature controlled, for example, the beverage container, in order to be able to implement an effective heat exchange. Since the sizes and shapes of different beverage containers to some extent differ considerably from one another, temperature-control surfaces always represent a compromise solution, the temperature-control effect of which depends on the actual contact surface between the beverage container to be temperature controlled and the temperature-control surface.

Temperature control devices having temperature-controllable bottom surfaces are often used, in which the temperature-control effect first occurs in the bottom region of the beverage container. This inhomogeneous temperature control leads to a comparatively low temperature-control effectiveness and leads to comparatively long temperature control times.

In the case of temperature-controllable storage units for controlling the temperature of a plurality of objects, the temperature-control effect in known solutions is regularly dependent on the object position, so that, for example, objects in a first row are temperature controlled more quickly than objects in a second row.

In addition, aluminum housings are regularly used in known temperature-controllable storage units, which lead to a high weight and high production costs. Furthermore, the known temperature-controllable storage units regularly have a complex electronic control, which increases the development costs on the one hand and the production costs on the other.

In the vehicle sector, solutions are also known in which the temperature control of objects is carried out using the vehicle internal air conditioning system. Corresponding systems, however, have limited temperature-control performance, so that long temperature control times occur. In addition, the integration of corresponding systems into the vehicle's internal air duct is associated with considerable effort. Furthermore, the temperature control of objects in this case depends on the operation of the air conditioning system.

### SUMMARY

The object on which the invention is based thus consists in improving the temperature control of objects and thus at least partially overcoming the disadvantages known from the prior art.

The object is achieved by an air temperature-controllable module of the type mentioned above, the useful air path in the useful air temperature-controllable region of the air temperature-controllable unit and the waste air path in the waste air temperature-controllable region of the air temperature-controllable unit running at an angle to one another. The invention makes use of the knowledge that the separation of the useful air flow from the waste air flow prevents the temperature-control performance from being impaired. The useful air path in the useful air temperature-controllable region of the air temperature-controllable unit and the waste air path in the waste air temperature-controllable region of the air temperature-controllable unit running at an angle to one another simplifies the sealing of the useful air path from the waste air path in the transition region to the air temperature-controllable unit, so that heat exchange between the useful air flow and the waste air flow can also be essentially avoided in the transition region to the air temperature-controllable unit. There is thus no undesired temperature change in the useful air flow due to the waste air flow.

It is also advantageous when a temperature-controllable module and a temperature-control container (for example, an integrated cooler or a storage or glove compartment) are or can be decoupled from one another.

They can be mounted at a distance from one another or dismantled and replaced separately. However, an already existing temperature-control container (for example, an ordinary glove compartment) can then simply be retrofitted or connected to a temperature-controllable module according to the invention. When the cooling of a storage compartment is not part of the standard equipment, a conventional plastic housing would have to be replaced by a housing made of aluminum for a conductive system according to the prior art. These additional costs for two different systems and the tools thereof are eliminated using the system that is decoupled according to the invention. That is because the same storage compartment can always be used here, regardless of whether a temperature-controllable module is provided or not. In addition, the temperature-controllable module can be used for other vehicles or other applications or recycled, since it can be decoupled from the storage compartment.

The useful air path in the useful air temperature-controllable region and the waste air path in the waste air temperature-controllable region preferably run at right angles, that is, offset by 90 degrees, to one another. The useful air flow direction preferably runs at an angle to the waste air flow direction in the region of the air temperature-controllable unit, particularly at a right angle, that is, offset by 90°. The useful air flow direction thus does not run parallel to the waste air flow direction in the region of the air temperature-controllable unit. The useful air path and the waste air path preferably lie in different flow planes. As a result, the useful air flow and the waste air flow are thermally separated or insulated from one another. The at least one thermoelectric device is preferably designed as a Peltier element or as a Seebeck element.

The air temperature-controllable module according to the invention can be used for heating and/or cooling the useful air. Thus, either heated and/or cooled waste air can be transported away via the waste air path. The air temperature-controllable module can be used as an autonomous system in a variety of different areas of application. For example, the temperature-controlled useful air can be used to control the temperature of beverage containers, mobile devices such as smart phones or tablets, batteries, particularly vehicle batteries, electronic devices or food. The designated objects can be cooled and/or heated by means of the temperature-controlled useful air of the air temperature-controllable module. Furthermore, the air temperature-controllable module according to the invention also allows a current object temperature to be maintained.

In a preferred embodiment of the air temperature-controllable module according to the invention, heat exchange devices are arranged within the useful air temperature-controllable region and/or within the waste air temperature-controllable region, wherein the heat exchange devices preferably each comprise heat exchange ribs and/or heat exchange fins. The useful air flow and the waste air flow are preferably located in spaced parallel planes. The heat exchange devices promote heat exchange between the at least one thermoelectric device and the useful air or the waste air. The heat exchange ribs and/or the heat exchange fins of the respective heat exchange devices each extend in the flow direction. The heat exchange ribs and/or the heat exchange fins of the heat exchange device arranged within the useful air temperature-controllable region preferably extend in a different direction than the heat exchange ribs and/or the heat exchange fins of the heat exchange device arranged within the waste air temperature-controllable region.

In addition, an air temperature-controllable module according to the invention is advantageous when the heat exchange ribs and/or heat exchange fins of the heat exchange device arranged within the useful air temperature-controllable region extend at an angle, particularly offset by 90 degrees, to the heat exchange ribs and/or heat exchange fins of the heat exchange device arranged within the waste air temperature-controllable region. The heat exchange ribs and/or heat exchange fins of the heat exchange device arranged within the useful air temperature-controllable region are preferably rotated 90 degrees in relation to the heat exchange ribs and/or heat exchange fins of the heat exchange device arranged within the waste air temperature-controllable region. The useful air flow and the waste air flow intersect as a result of the design of the heat exchange devices, so that the useful air flow and the waste air flow are guided in a cross flow. The inlets and outlets of the useful air temperature-controllable region and the waste air temperature-controllable region can be better separated from one another in a cross flow. The heat exchange devices can be glued to the thermoelectric device, so that no separate fixing of the heat exchange devices is necessary. Furthermore, a thermal bridge between the useful side and the waste air side of the thermoelectric device is avoided by any connection or fastening elements for the heat exchange devices due to the gluing.

An air temperature-controllable module according to the invention is also preferred in which the heat exchange ribs and/or heat exchange fins of the heat exchange device arranged within the useful air temperature-controllable region and the heat exchange ribs and/or heat exchange fins of the heat exchange device arranged within the waste air temperature-controllable region have different profiles. The heat exchange ribs and/or heat exchange fins of the heat exchange device arranged within the useful air temperature-controllable region can be arranged closer to one another than the heat exchange ribs and/or heat exchange fins of the heat exchange device arranged within the waste air temperature-controllable region. Alternatively, the heat exchange ribs and/or heat exchange fins of the heat exchange device arranged within the waste air temperature-controllable region can be arranged closer to one another than the heat exchange ribs and/or heat exchange fins of the heat exchange device arranged within the useful air temperature-controllable region. The heat exchange fins of the heat exchange device arranged within the useful air temperature-controllable region and the heat exchange fins of the heat exchange device arranged within the waste air temperature-controllable region can have different folds. The heat exchange fins of the heat exchange device arranged within the useful air temperature-controllable region can be folded more densely or more widely than the heat exchange fins of the heat exchange device arranged within the waste air temperature-controllable region. A tight fold ensures the largest possible heat exchange surface and improves the heat exchange properties of the heat exchange device. A spread fold or a larger lamella spacing prevents the respective air path from clogging due to freezing condensate drops. The heat exchange fins of the heat exchange device arranged within the useful air temperature-controllable region and/or the heat exchange fins of the heat exchange device arranged within the waste air temperature-controllable region can be folded into triangles resting on one another. The heat exchange fins of the heat exchange device arranged within the useful air temperature-controllable region and/or the heat exchange fins of the heat exchange device arranged within the waste air temperature-controllable region can be folded in a rectangular sawtooth pattern. Condensate droplets settle less well in a rectangular sawtooth pattern and ice formation leading to clogging of the respective air path occurs less often. As an additional measure against the formation of condensation, the surfaces of the heat exchange device arranged within the useful air temperature-controllable region and/or the surfaces of the heat exchange device arranged within the waste air temperature-controllable region can comprise a water-repellent profile and/or coating. The coating can be, for example, a hydrophobic nano-coating having a thickness of micrometers.

The air temperature-controllable module according to the invention is further advantageously developed in that the heat exchange device arranged within the useful air temperature-controllable region and/or the heat exchange device arranged within the waste air temperature-controllable region each have one or more protruding regions within which the respective heat exchange device protrudes laterally beyond the thermoelectric device. The heat exchange devices preferably each comprise a base plate and heat exchange ribs and/or heat exchange fins arranged at least partially on the base plate. The base plate, the heat exchange ribs and/or the heat exchange fins can protrude laterally beyond the thermoelectric device. The result is a protrusion of the heat exchange devices in relation to the thermoelectric device. An undesired heat exchange between the useful air flow and the waste air flow often results from poor insulation of the two air flows from one another and particularly from leaks in the edge regions of the thermoelectric device. The protrusions allow a significantly better sealing of the inlets and outlets of the useful air temperature-controllable region and the waste air temperature-controllable region. Improved sealing is particularly important when the air pressures differ from one another along the useful air path and along the waste air path. This is often the case in practice since the respective delivery rates differ from one another.

In another embodiment of the air temperature-controllable module according to the invention, the heat exchange device arranged within the useful air temperature-controllable region comprises a protruding region lying in front of the thermoelectric device in the flow direction of the useful air flow and/or a protruding region lying behind the thermoelectric device in the flow direction of the useful air flow. Alternatively or additionally, the heat exchange device arranged within the waste air temperature-controllable region comprises a protruding region lying in front of the thermoelectric device in the flow direction of the waste air flow and/or a protruding region lying behind the thermoelectric device in the flow direction of the waste air flow. The heat exchange devices preferably protrude over the thermoelectric device along the respective flow direction. In a plan view, the heat exchange device arranged within the useful air temperature-controllable region and the heat exchange device arranged within the waste air temperature-controllable region preferably form a cross-shaped structure. The useful air path and the waste air path can thus run further apart from one another beyond the thermoelectric device, so that, for example, a sheathing having an insulation material thickness of 3-10 mm can be implemented.

In addition, an air temperature-controllable module according to the invention is preferred in which the useful air temperature-controllable region of the air temperature-controllable unit is connected to a useful air inlet channel and/or to a useful air outlet channel, wherein a seal is arranged in each case between the useful air temperature-controllable region and the useful air inlet channel and/or between the useful air temperature-controllable region and the useful air outlet channel. Alternatively or additionally, the waste air temperature-controllable region of the air temperature-controllable unit is connected to a waste air inlet channel and/or to a waste air outlet channel, wherein a seal is arranged in each case between the waste air temperature-controllable region and the waste air inlet channel and/or between the waste air temperature-controllable region and the waste air outlet channel. The one or more seals are preferably sealing strips. The seals prevent useful air or waste air from escaping and/or transferring. The seals are preferably designed to be elastic. The seals are preferably sticky, so that leakage due to embrittlement is avoided even when the material ages. The seals are preferably arranged on the protruding regions of the heat exchange device arranged within the useful air temperature-controllable region and/or on the protruding regions of the heat exchange device arranged within the waste air temperature-controllable region. The seals can be Buthy bands.

In addition, an air temperature-controllable module according to the invention is advantageous when it comprises a useful air fan which is set up to generate the useful air flow along the useful air path. Alternatively or additionally, the air temperature-controllable module comprises a waste air fan which is set up to generate the waste air flow along the waste air path. The use of different fans within the useful air path and the waste air path allows, on the one hand, precise and needs-based temperature control of the useful air and, on the other hand, effective removal of the waste air.

In a preferred embodiment of the air temperature-controllable module according to the invention, said module comprises a multi-part module housing, wherein the useful air path and/or the waste air path is at least partially formed by air channels within the module housing. In particular, the module housing is made from a plastic material. The air temperature-controllable unit, the useful air fan and/or the waste air fan is preferably arranged within the module housing.

In addition, an air temperature-controllable module according to the invention is preferred in which the module housing comprises a first part and a second part, wherein the air temperature-controllable unit, the useful air fan and/or the waste air fan are arranged between the first part and the second part. The first part and/or the second part can be formed from a thermal insulation material. The thermal insulation material can comprise, for example, expanded polypropylene (EPP), modified polyphenylene ether (MPPE) or polyamide foam. The air temperature-controllable unit, the useful air fan and/or the waste air fan are preferably arranged within recesses in the first part and/or the second part of the module housing. The air temperature-controllable unit, the useful air fan and/or the waste air fan are preferably fixed between the first part and the second part of the module housing without fastening means, wherein the air temperature-controllable unit, the useful air fan and/or the waste air fan can be inserted or plugged into the module housing. The air temperature-controllable unit, the useful air fan and/or the waste air fan are fixed within the module housing via a form fit. In addition, the two fans can be integrated into corresponding cavities in the module housing without their own housing. The blade wheels therefore use the module housing as a wall. This is possible primarily through the use of mechanically stable foams from which the module housing is made. The foam surrounding the cavity thereby takes on the function of a wall and protects against external mechanical loads. It takes on the shape of the air duct through the cavity. The costs for the two fans can be reduced in this way. The foam-based module housing also provides soundproofing and thus a reduced perceptible noise level during operation of the air temperature-controllable module. In particular, the fan noise of the useful air fan and/or the waste air fan is attenuated by the module housing.

In addition, an air temperature-controllable module according to the invention is advantageous when the first part of the module housing comprises a recess encompassing the useful air path or the waste air path, at least in sections, and the second part of the module housing comprises a material projection extending in sections parallel to the useful air path or waste air path, which material projection protrudes into the recess of the first part. The recess is preferably deeper than the height of the material projection, so that a corresponding useful air path or waste air path results, the height of which corresponds at least in sections to the difference between the recess depth and the material projection height. This ensures that the useful air path and the waste air path run in different flow planes at least in sections, wherein the flow planes can be aligned parallel to one another. This constructive measure makes it possible to separate the useful air path from the waste air path in a comparatively simple manner.

In a further embodiment of the air temperature-controllable module according to the invention, the first part of the module housing comprises the waste air inlet and the waste air outlet and/or the second part of the module housing comprises the useful air inlet and the useful air outlet. The waste air inlet of the module housing is preferably arranged below the waste air outlet of the module housing. The useful air inlet of the module housing is preferably arranged below the useful air outlet of the module housing. In particular, the waste air inlet direction of the module housing is offset by 90° to the waste air outlet direction of the module housing. The useful air inlet direction and the useful air outlet direction run essentially parallel to one another.

Furthermore, an air temperature-controllable module according to the invention is preferred in which the useful air path and the waste air path are formed separately from one another over the entire length. In particular, the useful air path and the waste air path do not have a common subsection. An exchange of air between the useful air path and the drainage path is thus avoided. Furthermore, there is little or no heat exchange between the useful air flow and the waste air flow.

In another preferred embodiment of the air temperature-controllable module according to the invention, the useful air fan and/or the waste air fan are each designed as a radial fan. With radial fans, air is sucked in parallel or axially to the drive axis of the fan and deflected by 90° by the rotation of the radial impeller and blown out again in the radial direction. A corresponding design of the useful air fan or the waste air fan can achieve an increased air throughput, whereby the temperature-control performance of the air temperature-controllable module is increased. In particular, the use of appropriate radial fans favors the provision of pre-temperature-controlled useful air and the removal of the heated or cooled waste air.

In addition, an air temperature-controllable module according to the invention is advantageous when it comprises a control device by means of which the useful air fan and the waste air fan can be controlled independently of one another. In particular, the rotary speed of the useful air fan can be set independently of the rotary speed of the waste air fan. The air throughput generated by the useful air fan can thus also be adjusted independently of the air throughput generated by the waste air fan.

The control device is preferably set up to set the voltage and/or current strength applied to the thermoelectric device. Furthermore, the control device can be set up to temporarily reverse the voltage applied to the thermoelectric device. Just a few seconds of voltage reversal are sufficient to melt and evaporate ice on a clogged heat exchange device. The brief voltage reversal does not impair the operation of the air temperature-controllable module. For example, a drop in the power consumption of the thermoelectric device, a long-lasting temperature change in the useful air flow and/or the waste air flow, an overshooting of and/or a falling below of a limit temperature in the useful air flow and/or the waste air flow and/or a reduced air delivery rate in the useful air flow and/or the waste air flow can be used to trigger a regulated or timer-controlled defrosting.

In a further development of the air temperature-controllable module according to the invention, the control device is set up to control the useful air fan, the waste air fan and/or the air temperature-controllable unit as a function of a counter pressure and/or a temperature control requirement. The temperature control requirement can be a function of, for example, the temperature of an object to be temperature controlled by means of the useful air and/or a target temperature for an object to be temperature controlled by means of the useful air. In particular, the waste air fan can also be controlled as a function of the ambient temperature. The control device thus allows the setting of a suitable rotational speed on the useful air fan and/or the waste air fan and the setting of the pressure change generated by the useful air fan and/or the waste air fan. Furthermore, the supply power made available to the air temperature-controllable unit can also be controlled via the control device. The heat pump output between the useful air side and the waste air side of the thermoelectric device can be controlled in this way when the air temperature-controllable unit comprises a thermoelectric device.

The object on which the invention is based is further achieved by a temperature-controllable storage unit of the type mentioned above, the air temperature-controllable module of the temperature-controllable storage unit according to the invention being designed according to one of the embodiments described above. With regard to the advantages and modifications of the temperature-controllable storage unit according to the invention, reference is therefore first made to the advantages and modifications of the air temperature-controllable module according to the invention.

By using a corresponding air temperature-controllable module, the temperature-control performance is not dependent, or only to a small extent dependent, on the shape and/or size of the one or more objects to be temperature controlled. Furthermore, the temperature-control performance does not depend on the arrangement or position of the one or more objects to be temperature controlled within the receiving region. This is due to the fact that the temperature control of the one or more objects is not implemented via a temperature-controllable surface, such as a temperature-controllable bottom section, but rather via a temperature-controlled useful air flow. A homogeneous temperature distribution results within the receiving region of the temperature-control container, so that the one or more objects are temperature controlled homogeneously. Furthermore, no direct contact of the one or more objects to be temperature controlled using a tempering surface is necessary. Overall, the storage unit according to the invention ensures faster heat transport. This applies to both the heat transport of the useful air flow and the heat transport of the waste air flow. In addition, the temperature-controllable storage unit allows the use of comparatively simple electronics, so that the development costs and the hardware costs are reduced.

In a further embodiment of the temperature-controllable storage unit according to the invention, the temperature-control container is made from a plastic material. The temperature-control container can be designed in one piece or in a plurality of parts. The use of plastic material means that the use of aluminum is not required. This results in a reduction in the weight of the temperature-control container and in reduced material and manufacturing costs.

In a particularly preferred embodiment of the temperature-controllable storage unit, the temperature-control container is made from a foamed material and/or comprises one or a plurality of film layers. In particular, the temperature-control container is made from a foamed plastic. Using foamed material further reduces the weight of the temperature-control container due to the low density of the foamed material. In addition, the air inclusions within the foamed material ensure a thermal insulation effect, so that an unintentional heat exchange between the receiving region of the temperature-control container and the surroundings is avoided or at least considerably reduced. Alternatively or additionally, the temperature-control container comprises one or a plurality of film layers, wherein the one or plurality of film layers can be formed by deep-drawn films. The one or plurality of films can be used as a viewing and/or outer film. In particular, the one or plurality of film layers have a class A surface. An insulation material, for example, foamed polyurethane, expanded polypropylene or modified polyphenylene ether, can be arranged on at least one film. The one or plurality of films and the insulation material can form a sandwich structure. For example, a film layer functioning as an outer film can be welded to the insulation material. This results in a weight and cost-saving optimal flexural rigidity and impact resistance of the composite material. Furthermore, there is no assembly step, since an insulated temperature-control container is used directly. When the insulation material is foamed polyurethane, the sandwich structure can be produced by a foaming process. When the insulation material is expanded polypropylene, modified polyphenylene ether or polyamide foam, the sandwich structure can be produced by a sintering process. Particularly preferred is a temperature-control container made from a deep-drawn film backed with polymer foam.

In addition, a temperature-controllable storage unit according to the invention is advantageous when the walls of the temperature-control container comprise a useful air inlet and/or a useful air outlet, wherein the useful air inlet of the temperature-control container is connected to the useful air outlet of the air temperature-controllable module and/or the useful air outlet of the temperature-control container is connected to the useful air inlet of the useful temperature-controllable module in a fluid-conducting manner. The useful air inlet and/or the useful air outlet is preferably arranged in the side wall of the temperature-control container. In particular, the useful air inlet of the temperature-control container is arranged above the useful air outlet of the temperature-control container. Cold air thus flows from above through the receiving region downwards in the cooling mode of the temperature-controllable storage unit. The useful air inlet and/or the useful air outlet is preferably molded into the walls of the temperature-control container. A ventilation grille or ventilation screen is preferably arranged in the region of the useful air inlet of the temperature-control container and/or in the region of the useful air outlet of the temperature-control container. The ventilation grilles or ventilation screens prevent the waste air fan and/or the useful air fan from unintentionally coming into contact with the limbs of a user, for example, coming into contact with a finger. This increases the operational safety considerably.

The temperature-controllable storage unit according to the invention is further advantageously developed when the useful air path, the useful air temperature-controllable region and/or the useful air fan of the air temperature-controllable module and/or the receiving region of the temperature-control container are integrated into an air flow circuit. The useful air circulates within the air flow circuit. An effective and operative temperature control is implemented due to the air circulation, since pre-temperature-controlled air is used several times. The constant renewed control of temperature of the sucked in ambient air is thus effectively avoided. Thus, in addition to maintaining the temperature of an object, considerable temperature adjustments of the object to be temperature controlled can also be implemented in a comparatively short time by means of the useful air flow. In addition, the formation of condensation water is avoided, since the circulating useful air is essentially completely dried after a few circulations.

The waste air path, the waste air temperature-controllable region and/or the waste air fan of the air temperature-controllable module are preferably integrated into an open flow loop which does not allow the waste air to circulate. There is no multiple use of the waste air. The waste air fan thus sucks in air from the surroundings and then expels the waste air into the surroundings so that the temperature control within the temperature-control container is not impaired.

In another embodiment of the temperature-controllable storage unit according to the invention, the temperature-control container is at least partially surrounded by thermal insulation, particularly by a thermal insulation container, made of a thermal insulation material. The thermal insulation material can be, for example, expanded polypropylene (EPP), polyurethane or modified polyphenylene ether (MPPE) or polyamide foam.

The temperature-controllable storage unit according to the invention preferably comprises a cover for the temperature-control container. The cover can be made of the same material as the temperature-control container. The cover can be connected to the temperature-control container by means of a hinge. The cover reduces or prevents heat exchange and/or fluid exchange with the surroundings.

In a further development of the temperature-controllable storage unit according to the invention, at least a part of the module housing of the air temperature-controllable module forms at least one section of the thermal insulation. The second part of the module housing of the air temperature-controllable module is preferably a wall section of the thermal insulation container. In particular, the second part of the module housing of the air temperature-controllable module is arranged between the first part of the module housing and the temperature-control container, so that a sandwich structure results in this region. The thermal insulation can also be a load-bearing structure at the same time.

The temperature-control container can be a cooling and/or heating container. It is advantageous to create a structure on the bottom that allows air to circulate between the object to be temperature controlled and the bottom. For this purpose, fins, for example, can be used as spacers on the bottom. Particularly when cooling, it can be advantageous to generate an air flow at least when opening a housing cover of the module housing, which air flow acts as an air curtain and holds the temperature-controlled air in the temperature-control container and/or returns it thereto. This is particularly relevant in the case of vertically arranged openings in the temperature-control container, because there cold air easily falls out downwards and warm air rises outwards upwards.

Furthermore, a temperature-controllable storage unit according to the invention is preferred in which the temperature-control container is set up to receive beverage containers. For example, the temperature-control container can be set up to receive bottles, cups or cans. In particular, a holding device can also be arranged inside the temperature-control container, by means of which holding device the beverage containers to be temperature controlled are fixed within the receiving region.

The temperature-controllable storage unit according to the invention can further be used for temperature control of mobile devices such as smart phones or tablets, for temperature control of batteries, particularly vehicle batteries, for temperature control of electronic devices and/or for temperature control of food.

### BRIEF DESCRIPTION OF THE DRAWINGS

Preferred embodiments of the invention are explained and described in more detail below with reference to the accompanying drawings. Shown are:

FIG. 1 an embodiment of the temperature-controllable storage unit according to the invention in a sectional representation;

FIG. 2 the temperature-controllable storage unit shown in FIG. 1 in a partially transparent perspective representation;

FIG. 3 the temperature-controllable storage unit shown in FIG. 1 in an exploded representation;

FIG. 4 an embodiment of the air temperature-controllable module according to the invention in an exploded representation;

FIG. 5 the air temperature-controllable module shown in FIG. 4 in a further exploded representation;

FIG. 6 a first part of a module housing of an air temperature-controllable module according to the invention in a top view;

FIG. 7 a second part of a module housing of an air temperature-controllable module according to the invention in a top view;

FIG. 8 a further embodiment of the air temperature-controllable module according to the invention in a sectional representation;

FIG. 9 an air temperature-controllable unit of an air temperature-controllable module according to the invention in a perspective representation;

FIG. 10 an air temperature-controllable unit of an air temperature-controllable module according to the invention in a side view;

FIG. 11 the air temperature-controllable unit depicted in FIG. 10 in a top view;

FIG. 12 the air temperature-controllable unit depicted in FIG. 10 in a further side view;

FIG. 13 the air temperature-controllable unit depicted in FIG. 10 in a view from below;

FIG. 14 an air temperature-controllable unit of an air temperature-controllable module according to the invention in a perspective representation;

FIG. 15 an embodiment of the temperature-controllable storage unit according to the invention in a schematic representation;

FIG. 16 a further embodiment of the temperature-controllable storage unit according to the invention in a schematic representation; and

FIG. 17 a further embodiment of the temperature-controllable storage unit according to the invention in a schematic representation.

### DETAILED DESCRIPTION

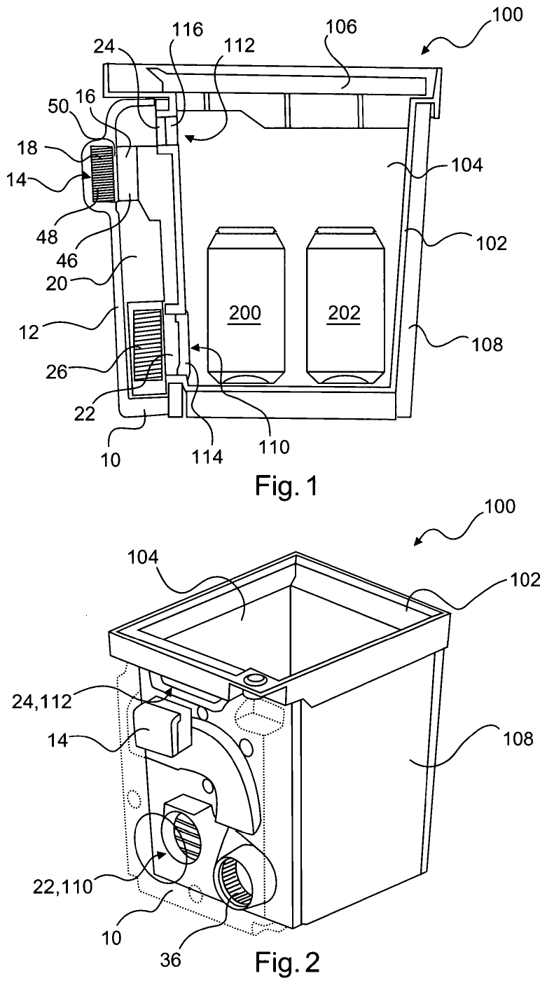

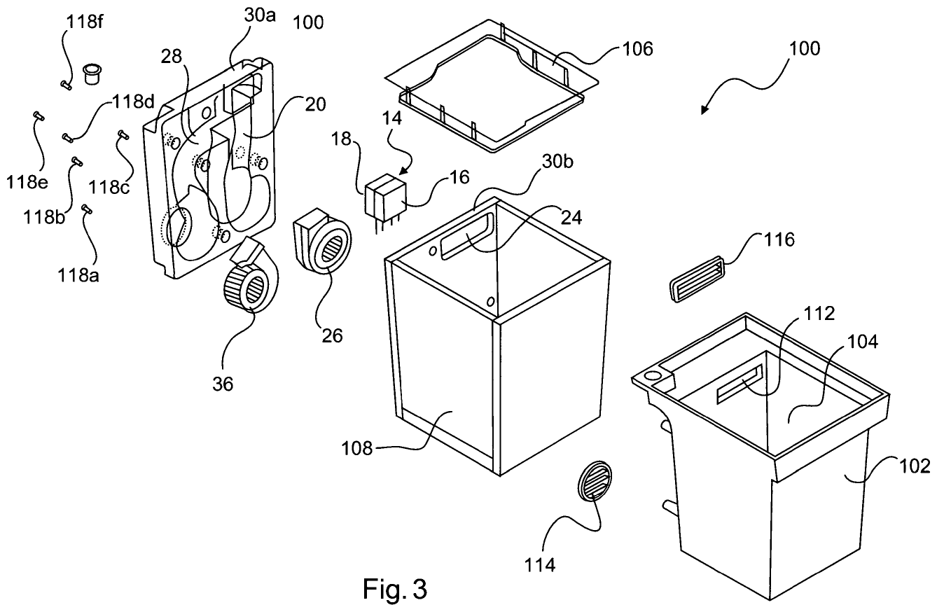

FIGS. 1 to 3 show a temperature-controllable storage unit 100 having a temperature-control container 102. The temperature-control container 102 comprises a receiving region 104 within which two objects 200, 202, namely beverage cans, are positioned in FIG. 1. The objects 200, 202 can be temperature-controlled by a temperature-controlled useful air flow introduced into the receiving region 104 by means of the temperature-controllable storage unit 100. In the present case, the objects 200, 200 are cooled by the temperature-controlled useful air flow introduced into the receiving region 104, wherein the objects 200, 202 are also able to be heated by means of the temperature-controllable storage unit 100.

The temperature-controllable storage unit 100 is set up to be used inside a vehicle.

The storage unit 100 comprises an air temperature-controllable module 10 to generate the temperature-controlled useful air flow. The air temperature-controllable module 10 comprises an air temperature-controllable unit 14 which comprises a useful air temperature-controllable region 16 and a waste air temperature-controllable region 18. The air temperature-controllable unit 14 comprises a thermoelectric device 50 designed as a Peltier element. The thermoelectric device 50 comprises a useful air side and a waste air side. The useful air side is connected to the useful air temperature-controllable region 16 in a heat-transmitting manner via a heat exchange device 46. The waste air side is connected to the waste air temperature-controllable region 18 in a heat-transmitting manner via a heat exchange device 48. The heat exchange devices 46, 48 comprise a plurality of heat exchange ribs or heat exchange fins.

The air temperature-controllable module 10 comprises a useful air path 20 which extends from a useful air inlet 22 of the air temperature-controllable module 10 to a useful air outlet 24 of the air temperature-controllable module 10. Furthermore, the useful air path 20 connects the useful air temperature-controllable region 16 of the air temperature-controllable unit 14 in a fluid-conducting manner to the useful air outlet 24 of the air temperature-controllable module 10. A useful air flow 42 is generated along the useful air path 20 via a useful air fan 26 designed as a radial fan.

The air temperature-controllable module 10 also comprises a waste air path 28 extending from a waste air inlet 32 of the air temperature-controllable module 10 to a waste air outlet 34 of the air temperature-controllable module 10. Furthermore, the waste air path 28 connects the waste air temperature-controllable region 18 of the air temperature-controllable unit 14 to the waste air outlet 34 of the air temperature-controllable module 10 in a fluid-conducting manner. The useful air path 20 and the waste air path 28 are formed separately from one another over the entire length and do not have a common subsection. An exchange of air between the useful air path 20 and the waste air path 28 and heat exchange between the useful air path 20 and the waste air path 28 are thus avoided. A waste air flow 44 is generated along the waste air path 28 via a waste air fan 36 designed as a radial fan.

The air temperature-controllable module 10 comprises a multi-part module housing 12, wherein the useful air path 20 and the waste air path 28 are formed by air channels within the module housing 12. The parts 30a, 30b of the module housing 12 are fastened to one another via fastening means 118a-118f designed as screws.

The wall of the temperature-control container 102 comprises a useful air inlet 112 and a useful air outlet 110. The useful air inlet 112 of the temperature-control container 102 is connected to the useful air outlet 24 of the air temperature-controllable module 10 in a fluid-conducting manner. The useful air outlet 110 of the temperature-control container 102 is connected to the useful air inlet 22 of the air temperature-controllable module 10 in a fluid-conducting manner. The result is that the useful air path 20 of the air temperature-controllable module 10 connects the useful air temperature-controllable region 16 of the temperature control unit to the receiving region 104 of the temperature-control container 102 in a fluid-conducting manner. Furthermore, the waste air path 28 of the air temperature-controllable module 10 connects the waste air temperature-controllable region 18 of the air temperature-controllable unit 14 to the surroundings of the storage unit 100 in a fluid-conducting manner.

The temperature-control container 102 is formed in one piece and made of a foamed plastic material. The temperature-control container 102 can be closed with a cover 106 and is surrounded by a thermal insulation 108, namely a thermal insulation container, made of a thermal insulation material. The thermal insulation material can be, for example, expanded polypropylene (EPP) or modified polyphenylene ether (MPPE). A part of the module housing 12 of the air temperature-controllable module 10 forms a section of the thermal insulation 108. In the present case, the thermal insulation 108 is a supporting structure.

The useful air inlet 112 of the temperature-control container 102 is arranged above the useful air outlet 110 of the temperature-control container 102. Ventilation grilles 114, 116 are arranged in each case in the region of the useful air inlet 112 of the temperature-control container 102 and the useful air outlet 110 of the temperature-control container 102.

The useful air path 20, the useful air temperature-controllable region 16 and the useful air fan 26 of the air temperature-controllable module 10 and the receiving region 104 of the temperature-control container 102 are integrated into an air flow circuit within which the temperature-controlled useful air circulates. The waste air path 28, the waste air temperature-controllable region 18 and the waste air fan 36 of the air temperature-controllable module 10 are integrated into an open flow loop which does not allow any circulation of the waste air. The waste air fan 36 sucks in air from the surroundings and then expels the waste air back again into the surroundings after it has passed through the waste air temperature-controllable region 18 of the air temperature-controllable unit 14.

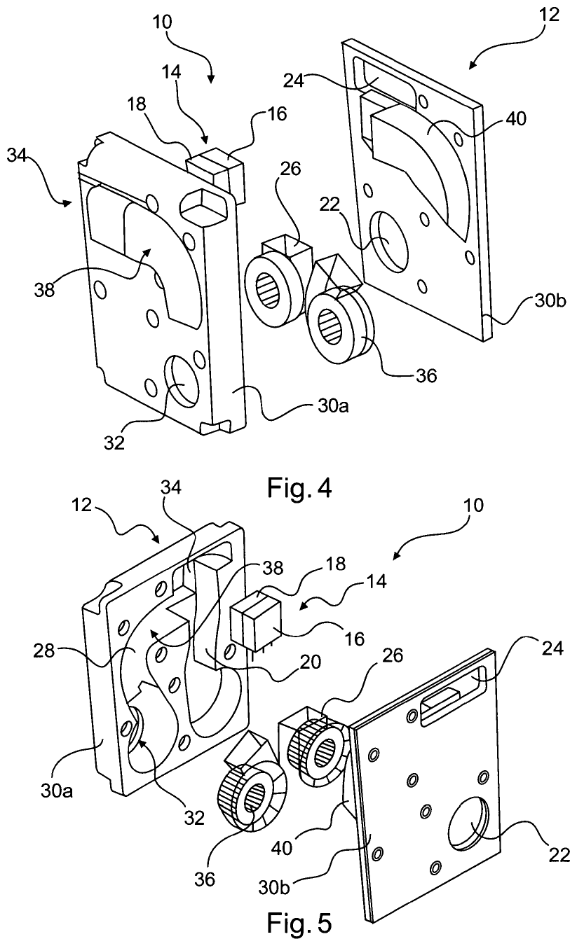

FIGS. 4 and 5 show an air temperature-controllable module 10 having a module housing 12, an air temperature-controllable unit 14, a useful air fan 26 and a waste air fan 28.

The module housing 12 is designed in two parts and comprises a useful air path 20 designed as an air channel and a waste air path 28 designed as an air channel. The useful air path 20 extends from a useful air inlet 22 to a useful air outlet 24 and connects a useful air temperature-controllable region 16 of the air temperature-controllable unit 14 to the useful air outlet 24 in a fluid-conducting manner. The waste air path 28 extends from a waste air inlet 32 to a waste air outlet 34 and connects a waste air temperature-controllable region 18 of the air temperature-controllable unit 14 to the waste air outlet 34 in a fluid-conducting manner.

The useful air fan 26 generates a useful air flow 42 along the useful air path 20. The waste air fan 36 generates a waste air flow 44 along the waste air path 28.

The module housing 12 is made of plastic and comprises a first part 30a and a second part 30b. The air temperature-controllable unit 14, the useful air fan 26 and the waste air fan 36 are arranged between the first part 30a and the second part 30b within recesses, so that the air temperature-controllable unit 14, the useful air fan 26 and the waste air fan 36 are fixed in the module housing 12 via a form fit.

The first part 30a of the module housing 12 comprises the waste air inlet 32 and the waste air outlet 34. The second part 30b of the module housing 12 comprises the useful air inlet 22 and the useful air outlet 24.

The first part 30a of the module housing 12 comprises a recess 38 which encompasses the waste air path 28 in sections. The second part 30b of the module housing 12 has a material projection 40 extending in sections parallel to the waste air path 28, which material projection 40 protrudes into the recess 38 of the first part 30a in the assembled state of the module housing 12. This ensures that the useful air path 20 and the waste air path 28 are located in different flow planes.

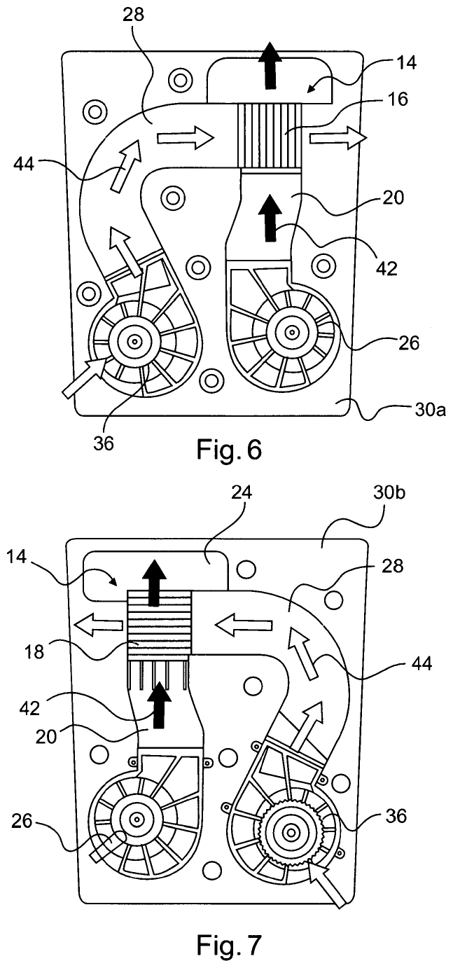

FIG. 6 shows a first part 30a of a module housing 12. The waste air path 28 extends from a covered waste air inlet 32 to a covered waste air outlet 34 and connects a waste air temperature-controllable region 18 (see FIG. 7) of the air temperature-controllable unit 14 to the waste air outlet 34 in a fluid-conducting manner. The waste air fan 36 designed as a radial fan is used to generate a waste air flow 44 along the waste air path 28.

FIG. 7 shows a second part 30b of a module housing 12. The useful air path 20 extends from a covered useful air inlet 22 via a useful air fan 26 to a useful air outlet 24 and connects a useful air temperature-controllable region 16 (see FIG. 6) of the air temperature-controllable unit 14 to the useful air outlet 24 in a fluid-conducting manner. The useful air fan 26 is designed as a radial fan and is used to generate a useful air flow 42 along the useful air path 20.

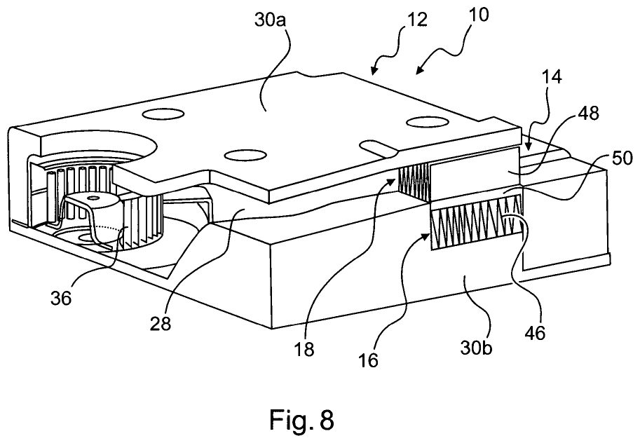

FIG. 8 shows the design and arrangement of the air temperature-controllable unit 14 within the module housing 12 of the air temperature-controllable module 10. The air temperature-controllable unit 14 comprises a thermoelectric device 50 designed as a Peltier element which comprises a useful air side and a waste air side. The useful side is connected to a useful air temperature-controllable region 16 in a heat-transmitting manner via a heat exchange device 46. The waste air side is connected to a waste air temperature-controllable region 18 in a heat-transmitting manner via a heat exchange device 48. The heat exchange devices 46, 48 each have a plurality of heat exchange fins, wherein the heat exchange fins of the heat exchange devices 46, 48 are arranged offset from one another by 90 degrees. The heat exchange fins of the heat exchange device 46 extend in the flow direction of the useful air. The heat exchange fins of the heat exchange device 48 extend in the flow direction of the waste air.

The air temperature-controllable module 10 can also comprise a control device by means of which the useful air fan 26 and the waste air fan 36 can be controlled independently of one another. The control device can control the useful air fan 26, the waste air fan 36 and the air temperature-controllable unit 14, for example, as a function of a counter pressure and/or a temperature control requirement.

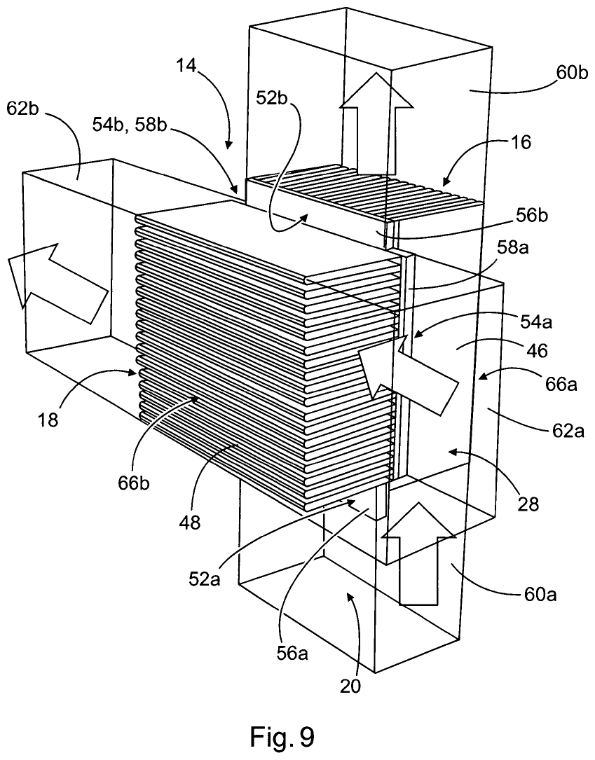

FIG. 9 shows an air temperature-controllable unit 14 of an air temperature-controllable module 10. The air temperature-controllable unit 14 comprises a useful air temperature-controllable region 16 and a waste air temperature-controllable region 18. Furthermore, the air temperature-controllable unit 14 comprises a thermoelectric device 50 designed as a Peltier element, which is covered in FIG. 9. The thermoelectric device 50 comprises a useful air side and a waste air side, wherein the useful air side is connected to the useful air temperature-controllable region 16 in a heat-transmitting manner and the waste air side is connected to the waste air temperature-controllable region 18 in a heat-transmitting manner.

A section of a useful air path 20, which runs through the air temperature-controllable unit 14, is also depicted. In addition, a section of a waste air path 28 is shown, which runs through the air temperature-controllable unit 14. The useful air path 20 in the useful air temperature-controllable region 16 of the air temperature-controllable unit 14 and the waste air path 28 in the waste air temperature-controllable region 18 of the air temperature-controllable unit 14 run at right angles to one another. As a result, the useful air path 20 in the useful air temperature-controllable region 16 and the waste air path 28 in the waste air temperature-controllable region 18 run offset from one another by 90 degrees. This leads to the useful air flow direction in the region of the air temperature-controllable unit 14 running at right angles to the waste air flow direction.

A heat exchange device 46 is arranged within the useful air temperature-controllable region 16. A heat exchange device 48 is arranged within the waste air temperature-controllable region 18. The heat exchange devices 46, 48 each comprise heat exchange fins 66a, 66b.

The useful air temperature-controllable region 16 is connected to a useful air inlet channel 60a and to a useful air outlet channel 60b. A seal 56a, 56b is arranged between the useful air temperature-controllable region 16 and the useful air inlet channel 60a and between the useful air temperature-controllable region 16 and the useful air outlet channel 60b. The waste air temperature-controllable region 18 is connected to a waste air inlet channel 62a and to a waste air outlet channel 62b. A seal 58a, 58b is arranged between the waste air temperature-controllable region 18 and the waste air inlet channel 62a and between the waste air temperature-controllable region 18 and the waste air outlet channel 62b. The seals 56a, 56b, 58a, 58b are designed as elastic, sticky sealing strips, which ensure a sealing effect even with increasing material aging and material embrittlement. The seals 56a, 56b, 58a, 58b are arranged in protruding regions 52a, 52b, 54a, 54b of the heat exchange devices 46, 48.

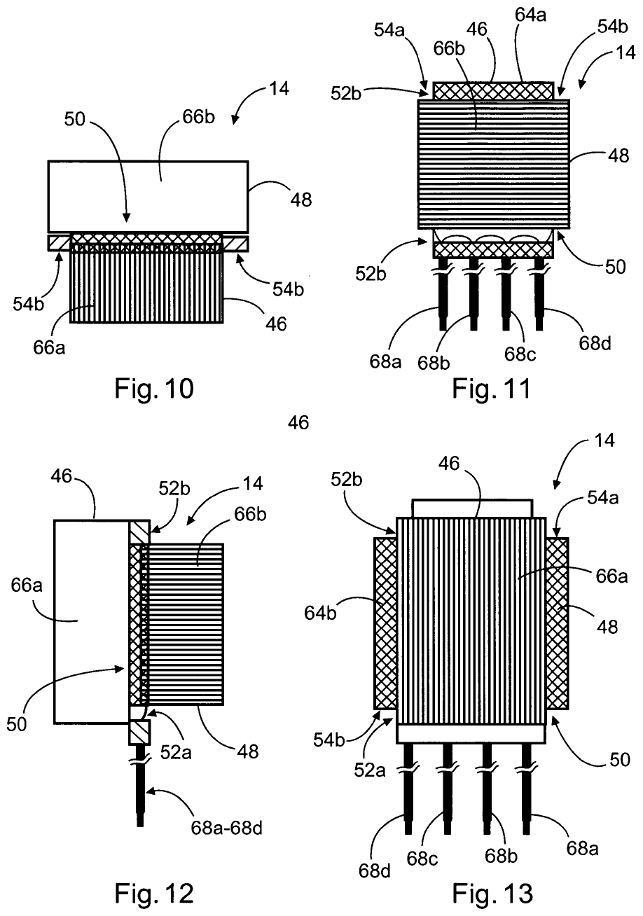

FIGS. 10 to 13 show an air temperature-controllable unit 14, the heat exchange devices 46, 48 of which also comprise protruding regions 52a, 52b, 54a, 54b. The respective heat exchange device 46, 48 projects beyond the thermoelectric device 50 within the protruding regions 52a, 52b, 54a, 54b. This results in a protrusion of the heat exchange devices 46, 48 in relation to the thermoelectric device 50. Seals can be arranged in the protruding regions 52a, 52b, 54a, 54b, so that the inlets and outlets of the useful air temperature-controllable region 16 and of the waste air temperature-controllable region 18 can be sealed much better. Heat exchange between the useful air flow and the waste air flow is thus further reduced.

The heat exchange device 46 arranged within the useful air temperature-controllable region 16 comprises a protruding region 52a lying in front of the thermoelectric device 50 in the flow direction of the useful air flow and a protruding region 52b lying behind the thermoelectric device 50 in the flow direction of the useful air flow. The heat exchange device 48 arranged within the waste air temperature-controllable region 18 comprises a protruding region 54a lying in front of the thermoelectric device 50 in the flow direction of the waste air flow and a protruding region 54b lying behind the thermoelectric device 50 in the flow direction of the waste air flow. The heat exchange devices 46, 48 protrude over the thermoelectric device 50 along the respective flow direction. In the plan view, the heat exchange devices 46, 48 form a cross-shaped structure.

The thermoelectric device 50 is further connected to connections 68a-68d, via which the thermoelectric device 50 can be supplied with electrical energy. A control device (not shown) can be set up to set the voltage and/or current strength applied to the thermoelectric device 50. For example, the heat exchange devices 46, 48 can be defrosted by means of a suitable setting of the voltage applied to the thermoelectric device 50 or the current strength applied to the thermoelectric device 50. For this purpose, the control device can be set up to temporarily reverse the voltage applied to the thermoelectric device 50, so that any ice that is present is melted and evaporated.

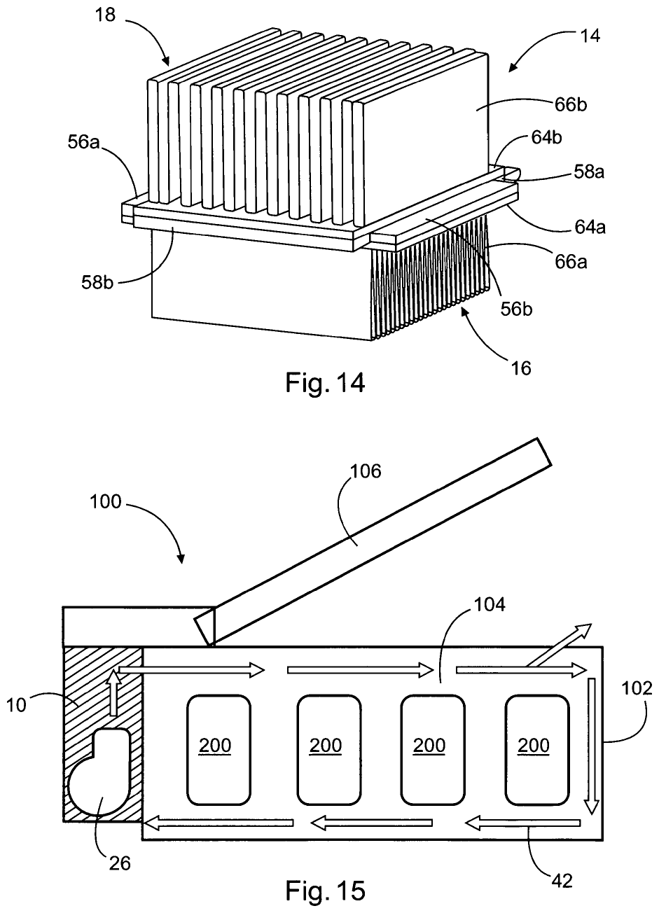

FIG. 14 shows an air temperature-controllable unit 14 in which the heat exchange devices 46, 48 each comprise heat exchange fins 66a, 66b which are arranged on a base plate 64a, 64b of the respective heat exchange device 46, 48. The heat exchange fins 66a of the heat exchange device 46 arranged within the useful air temperature-controllable region 16 extend at right angles to the heat exchange fins 66b of the heat exchange device 48 arranged within the waste air temperature-controllable region 18. The useful air flow and the waste air flow are guided like a cross flow due to the lamellar arrangement.

The heat exchange fins 66a of the heat exchange device 46 arranged within the useful air temperature-controllable region 16 and the heat exchange fins 66b of the heat exchange device 48 arranged within the waste air temperature-controllable region 18 have different profiles. That is, the heat exchange fins 66a and the heat exchange fins 66b have different folds. The heat exchange fins 66a are folded into triangles resting on one another. The heat exchange fins 66b are folded in a rectangular sawtooth pattern. The tight folding of the heat exchange fins 66a leads to a large heat exchange surface, so that a particularly intensive heat exchange can take place with the useful air flow. The large lamella spacing of the heat exchange fins 66b ensures a reduced risk of condensation formation, so that the air path is prevented from being clogged by freezing condensate droplets.

FIG. 15 shows a temperature-controllable storage unit 100 having an air temperature-controllable module 10 for temperature control of air and a temperature-control container 102, which is set up to receive a plurality of temperature-controllable objects 200, namely beverage containers, in a receiving region 104. The receiving region 104 of the temperature-control container 102 can be closed with a pivotable cover 106. When the cover 106 is opened, an air flow which acts as an air curtain is generated. The air curtain keeps the temperature-controlled air within the receiving region 104 of the temperature-control container 102 and prevents an intensive fluid and heat exchange with the surroundings.

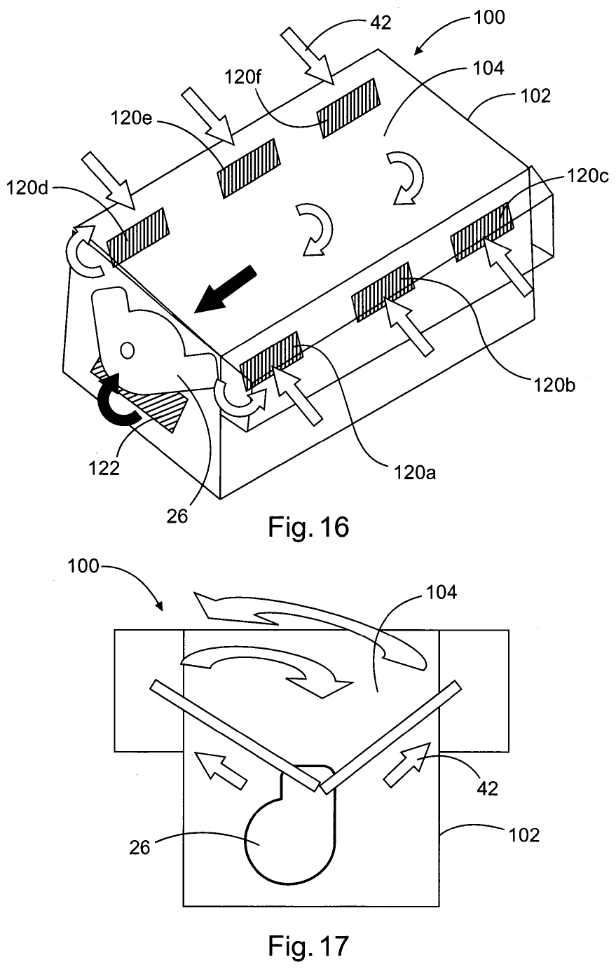

FIG. 16 shows a storage unit 100, the temperature-control container 102 of which comprises a plurality of useful air openings 120a-120f and a waste air opening 122. The useful air openings 120a-120f are used to implement an air curtain which prevents fluid and heat exchange with the surroundings when a cover 106 is opened.

FIG. 17 also shows a storage unit 100, in the temperature-control container 102 of which an air curtain can be produced.

Here, cooled air brushes along the inside of a cover or a door of a temperature-control container 102 or flows parallel thereto. In this way, an air curtain is formed that prevents air from escaping from the temperature-control container into the surroundings, even when the cover is open. This air flow can be the result of an ordinary operating condition of the system. However, to save energy, it can also be generated specifically when the cover is opened.

At least one heat exchanger is preferably provided with a water-repellent coating in order to reduce or avoid the formation of condensation. This is particularly desirable in the case of heat exchangers (often also referred to as heat conducting bodies) in the useful air region, since strong cooling could otherwise cause blockage due to icing.

It can be useful to briefly reverse the polarity of at least one thermoelectric device as a method for defrosting. As a result, a cooled side of the thermoelectric device is briefly heated (and a heated side is briefly cooled). The same applies to the heat exchangers/heat conducting bodies associated with these sides. This brief heating process melts disruptive ice and the air that then flows past (again) removes the condensation. A corresponding circuit or a corresponding switching device is expediently provided on the temperature-controllable module for this purpose.

It can be helpful to provide a drainage device (not shown) to remove condensate on a cold side of a thermoelectric device and a heat exchanger associated with this cold side. This drainage device can, for example, be or comprise a foam layer. The drainage device connects the cold side of the thermoelectric device to its warm side or their respective heat exchangers arranged there so that condensate is transported from the cold side to the warm side. The drainage device can be at least partially identical to a sealing device that separates a useful air flow from a waste air flow, particularly a sealing device on a temperature-controllable module, particularly a foam seal around a Peltier element. The drainage device sucks up the condensate on the cold side through a capillary, transports it to the warm side and evaporates it into the warm waste air flow.

The module housing preferably comprises prefabricated channels in a hardened polymer foam, in which the electrical connecting lines are received and held. In addition, plug-in receptacles can be provided in the foamed module housing, which receptacles enable electrical integration of an electronic control or other circuit board.

### Reference Numbers

10 air temperature-controllable module

12 module housing

14 air temperature-controllable unit

16 useful air temperature-controllable region

18 waste air temperature-controllable region

20 useful air path

22 useful air inlet

24 useful air outlet

26 useful air fan

28 waste air path

30a, 30b housing parts

32 waste air inlet

34 waste air outlet

36 waste air fan

38 recess

40 material projection

42 useful air flow

44 waste air flow

46 heat exchange device

48 heat exchange device

50 thermoelectric device

52a, 52b protruding regions

54a, 54b protruding regions

56a, 56b seals

58a, 58b seals

60a, 60b useful air inlet and useful air outlet channel

62a, 62b waste air inlet and waste air outlet channel

64a, 64b base plates

66a, 66b heat exchange fins

68a-68d connectors

100 storage unit

102 temperature-control container

104 receiving region

106 cover

108 thermal insulation

110 useful air outlet

112 useful air inlet

114 ventilation grille

116 ventilation grille

118a-118f fastening means

120a-120f useful air openings

122 waste air opening

200, 202 objects

1. An air temperature-controllable module for a temperature-controllable storage unit comprising:
an air temperature-controllable unit 04)-comprising a useful air temperature-controllable region, a waste air temperature-controllable region, and at least one thermoelectric device, the at least one thermoelectric device comprising a useful air side and a waste air side, the useful air side being connected to the useful air temperature-controllable region in a heat-transmitting manner, and the waste air side being connected to the waste air temperature-controllable region in a heat-transmitting manner;
a useful air path for a useful air flow, the useful air path extending from a useful air inlet to a useful air outlet and the useful air temperature-controllable region of the air temperature-controllable unit connecting to the useful air outlet in a fluid-conducting manner, and
a waste air path for a waste air flow, the waste air path extending from a waste air inlet to a waste air outlet and the waste air temperature-controllable region of the air temperature-controllable unit connecting to the waste air outlet in a fluid-conducting manner, wherein the useful air path in the useful air temperature-controllable region of the air temperature-controllable unit and the waste air path in the waste air temperature-controllable region of the air temperature-controllable unit run at an angle to one another.

2. The air temperature-controllable module according to claim 1, wherein a first and a second heat exchange device are arranged within the useful air temperature-controllable region and/or within the waste air temperature-controllable region, wherein the first and the second heat exchange devices, each comprise heat exchange ribs and/or heat exchange fins.

3. The air temperature-controllable module according to claim 2, wherein the heat exchange ribs and/or heat exchange fins of the first heat exchange device arranged within the useful air temperature-controllable region extend at an angle to the heat exchange ribs and/or heat exchange fins of the second heat exchange device arranged within the waste air temperature-controllable region.

4. The air temperature-controllable module according to claim 2, wherein the heat exchange ribs and/or heat exchange fins of the first heat exchange device arranged within the useful air temperature-controllable region and the heat exchange ribs and/or heat exchange fins of the second heat exchange device arranged within the waste air temperature-controllable region have different profiles.

5. The air temperature-controllable module according to claim 2, wherein the first heat exchange device arranged within the useful air temperature-controllable region and/or the second heat exchange device arranged within the waste air temperature-controllable region each comprise one or a plurality of protruding regions, within which the respective first and the second heat exchange device protrudes laterally beyond the thermoelectric device.

6. The air temperature-controllable module according to claim 5, wherein
the first heat exchange device arranged within the useful air temperature-controllable region comprises a protruding region lying in front of the thermoelectric device in the flow direction of the useful air flow and/or a protruding region lying behind the thermoelectric device in the flow direction of the useful air flow; and/or
the second heat exchange device arranged within the waste air temperature-controllable region comprises a protruding region lying in front of the thermoelectric device in the flow direction of the waste air flow and/or a protruding region lying behind the thermoelectric device in the flow direction of the waste air flow.

7. The air temperature-controllable module according to claim 1, wherein
the useful air temperature-controllable region of the air temperature-controllable unit is connected to a useful air inlet channel and/or to a useful air outlet channel, wherein a seal is arranged between the useful air temperature-controllable region and the useful air Inlet channel and/or between the useful air temperature-controllable region and the useful air outlet channel; and/or
the waste air temperature-controllable region of the air temperature-controllable unit is connected to a waste air inlet channel and/or to a waste air outlet channel, wherein a seal is arranged between the waste air temperature-controllable region and the waste air inlet channel and/or between the waste air temperature-controllable region and the waste air outlet channel.

8. The air temperature-controllable module according to claim 1, further comprising:
a useful air fan which is set up to generate the useful air flow along the useful air path, and/or
a waste air fan which is set up to generate the waste air flow along the waste air path.

9. The air temperature-controllable module according to claim 1, further comprising a multi-part module housing, wherein the useful air path and/or the waste air path is at least partially formed by air channels within a module housing.

10. The air temperature-controllable module according to claim 9, wherein the module housing comprises a first part and a second part, wherein the air temperature-controllable unit, the useful air fan and/or the waste air fan are arranged between the first part and the second part.

11. The air temperature-controllable module according to claim 10, wherein the first part of the module housing comprises a recess encompassing the useful air path or the waste air path at least in sections, and the second part of the module housing comprises a material projection extending in sections parallel to the useful air path or waste air path, which material projection protrudes into the recess of the first part.

12. The air temperature-controllable module according to claim 10, wherein the first part of the module housing comprises the waste air inlet and the waste air outlet and/or the second part of the module housing comprises the useful air inlet and the useful air outlet.

13. The air temperature-controllable module according to claim 1, wherein the useful air path and the waste air path are formed separately from one another over the entire length.

14. The air temperature-controllable module according to claim 1, wherein the useful air fan and/or the waste air fan are each designed as a radial fan.

15. The air temperature-controllable module according to claim 1, further comprising a control device by means of which the useful air fan and the waste air fan can be controlled independently of one another.

16. The air temperature-controllable module according to claim 15, wherein the control device is set up to control the useful air fan, the waste air fan and/or the air temperature-controllable unit as a function of a counter pressure and/or a temperature control requirement.

17. A temperature-controllable storage unit for a vehicle, the temperature-controllable storage unit comprising:
the air temperature-controllable module of claim 1 for temperature control of air; and
a temperature-control container which is set up to receive one or more objects to be temperature controlled in a receiving region, a useful air path of the air temperature-controllable module connecting a useful air temperature-controllable region of the temperature control unit to the receiving region of the temperature-control container in a fluid-conducting manner and a waste air path of the air temperature-controllable module connecting a waste air temperature-controllable region of the air temperature-controllable unit to the surroundings of the storage unit in a fluid-conducting manner.

18. The temperature-controllable storage unit according to claim 17, wherein the temperature-control container is made from a plastic material.

19. The temperature-controllable storage unit according to claim 17, wherein the temperature-control container is made from a foamed material and/or comprises one or a plurality of film layers.

20. The temperature-controllable storage unit according to claim 17, wherein the walls of the temperature-control container comprise a useful air inlet and/or a useful air outlet, wherein the useful air inlet of the temperature-control container is connected to the useful air outlet of the air temperature-controllable module and/or the useful air outlet of the temperature-control container is connected to the useful air inlet of the air temperature-controllable module.

21. The temperature-controllable storage unit according to claim 17, wherein the useful air path, the useful air temperature-controllable region, and/or the useful air fan of the air temperature-controllable module and/or the receiving region of the temperature-control container are integrated in an air flow circuit.

22. The temperature-controllable storage unit according to claim 17, wherein the temperature-control container is at least partially surrounded by thermal insulation.

23. The temperature-controllable storage unit according to claim 22, wherein at least a part of the module housing of the air temperature-controllable module forms at least a section of the thermal insulation.

24. The temperature-controllable storage unit according to claim 17, wherein the temperature-control container is set up to receive beverage containers.

25. A method for operating the air temperature-controllable module according to claim 1, wherein in a defrosting phase, at least one thermoelectric device is energized with reversed polarity compared to a cooling operation.
